(19) United States
(12) Patent Application Publication
(10) Pub. No.: US 2010/0053822 A1
(43) Pub. Date: Mar. 4, 2010

(54) STRAM CELLS WITH AMPERE FIELD ASSISTED SWITCHING

(75) Inventors: Haiwen Xi, Prior Lake, MN (US); Paul Anderson, Eden Prairie, MN (US); Zheng Gao, Savage, MN (US); Xiaobin Wang, Chanhassen, MN (US); Dimitar V. Dimitrov, Edina, MN (US); Song S. Xue, Edina, MN (US)

Correspondence Address: CAMPBELL NELSON WHIPPS, LLC, HISTORIC HAMM BUILDING, 408 SAINT PETER STREET, SUITE 240, ST. PAUL, MN, 55102, US

(73) Assignee: SEAGATE TECHNOLOGY LLC, Scotts Valley, CA (US)

(21) Appl. No.: 12/200,034

(22) Filed: Aug. 28, 2008

(51) Int. Cl. G11B 5/127

(52) U.S. Cl. 360/324.2; 977/935; G9B/5.04

(57) ABSTRACT

A magnetic tunnel junction cell that has a ferromagnetic pinned layer, a ferromagnetic free layer, and a non-magnetic barrier layer therebetween. The free layer has a larger area than the pinned layer, in some embodiments at least twice the size of the pinned layer, in some embodiments at least three times the size of the pinned layer, and in yet other embodiments at least four times the size of the pinned layer. The pinned layer is offset from the center of the free layer. The free layer has a changeable vortex magnetization, changeable between clockwise and counterclockwise directions.

### BACKGROUND

Spin torque transfer technology, also referred to as spin electronics, combines semiconductor technology and magnetics, and is a more recent development. In spin electronics, the spin of an electron, rather than the charge, is used to indicate the presence of digital information. The digital information or data, represented as a “0” or “1”, is storable in the alignment of magnetic moments within a magnetic element. The resistance of the magnetic element depends on the moment's alignment or orientation. The stored state is read from the element by detecting the component's resistive state. The magnetic element, in general, includes a ferromagnetic pinned layer and a ferromagnetic free layer, each having a magnetization orientation, and a non-magnetic barrier layer therebetween. The magnetization orientations of the free layer and the pinned layer define the resistance of the overall magnetic element. Such an element is generally referred to as a “spin tunneling junction,” “magnetic tunnel junction”, “magnetic tunnel junction cell”, or the like. When the magnetization orientations of the free layer and pinned layer are parallel, the resistance of the element is low. When the magnetization orientations of the free layer and the pinned layer are antiparallel, the resistance of the element is high.

At least because of their small size, it is desirous to use magnetic tunnel junction elements in memory applications. Memory that utilizes magnetic tunnel junction elements is referred to a spin-transfer torque memory, spin torque memory, spin torque RAM, STRAM, or the like. However, the small size of the magnetic tunnel junction elements creates issues.

One of the issues associated with spin torque memory (STRAM) is the current switching ability for each of the multitude of memory cells and the distribution of the switching currents. One possible reason for the inaccurate switching ability and distribution is the non-uniform current density through the barrier layer and thus a non-uniform spin torque. Another possible cause is that the current also generates a circular magnetic field that confounds the switching of the free layer magnetization. For instance, an ampere field generated by the current at the edge of a magnetic tunnel junction stack having a dimension of 100 nm and current density of 10⁷ A/cm² can be as large as 30 oersted (Oe). As a result, the free layer magnetization of the tunnel junction cell may have a resulting vortex structure. Therefore, in order to reduce the needed write current and achieve a uniform free layer magnetization, one would decrease the size of the memory stacks. However, when the memory cell is scaled down for high density, the magnetic tunnel junction stacks become so small that the free layer is subjected to thermal fluctuation and becomes thermally unstable.

### BRIEF SUMMARY

The present disclosure relates to magnetic tunnel junction cells that utilize spin torque and a current ampere field to assist in the switching of the magnetization orientation of the free layer of the magnetic tunnel junction cell. The resulting magnetization of the free layer has a vortex structure. The magnetic tunnel junction cells of this invention have a free layer having an increased size, which provides the vortex, non-uniform magnetization in the free layer without sacrificing readability. Additionally, the magnetic tunnel junction cells have improved thermal stability due to the increased area of the free layer.

In one particular embodiment, this disclosure describes a magnetic tunnel junction cell that has a ferromagnetic pinned layer, a ferromagnetic free layer, and a non-magnetic barrier layer therebetween. The free layer has an area at least twice the size of the pinned layer, in some embodiments at least three times the size of the pinned layer, and in yet other embodiments at least four times the size of the pinned layer.

In another particular embodiment, this disclosure describes a magnetic tunnel junction cell having a ferromagnetic pinned layer, a ferromagnetic free layer, and a non-magnetic barrier layer therebetween. The free layer has an area larger than that of the pinned layer, and the pinned layer is offset from a center of the free layer.

In yet another particular embodiment, this disclosure describes a magnetic tunnel junction cell having a ferromagnetic pinned layer having a fixed magnetization, a ferromagnetic free layer with an area larger than that of the pinned layer, the free layer having a changeable vortex magnetization, and a non-magnetic barrier layer between the pinned layer and the free layer. The vortex magnetization is changeable between clockwise and counterclockwise directions. In some embodiments, the magnetization of the pinned layer is fixed antiparallel to the vortex magnetization of the free layer proximate the pinned layer, and in other embodiments, the magnetization of the pinned layer is fixed parallel to the vortex magnetization of the free layer proximate the pinned layer.

Additional embodiments of magnetic tunnel junction cells are disclosed, as well as memory (STRAM) including the cells, and methods of making and using the cells.

These and various other features and advantages will be apparent from a reading of the following detailed description.

### BRIEF DESCRIPTION OF THE DRAWINGS

The disclosure may be more completely understood in consideration of the following detailed description of various embodiments of the disclosure in connection with the accompanying drawings, in which:

FIG. 1A is a schematic top view of a magnetic tunnel junction stack; FIG. 1B is an enlarged cross-sectional view taken along line B-B of FIG. 1A; and FIG. 1C is an enlarged cross-sectional view taken along line C-C of FIG. 1A;

FIG. 2A is a schematic top view of the magnetic tunnel junction stack of FIGS. 1A-1C, illustrating the magnetization configuration of the free layer with the programming current flow from the top to the bottom of the stack (from the pinned layer to the free layer); FIG. 2B is a schematic top view of the magnetic tunnel junction stack of FIGS. 1A-1C, illustrating the magnetization configuration of the free layer with the programming current flow from the bottom to the top of the stack (from the free layer to the pinned layer);

FIG. 3A is a schematic top view of a magnetic tunnel junction stack according to the disclosure; FIG. 3B is an enlarged cross-sectional view taken along line B-B of FIG. 3A;

FIG. 4A is a schematic top view of the magnetic tunnel junction stack of FIGS. 3A-3B, illustrating the magnetization configuration of the free layer with the programming current flow from the top to the bottom of the stack (from the pinned layer to the free layer); FIG. 4B is a schematic top view of the magnetic tunnel junction stack of FIGS. 3A-3B, illustrating the magnetization configuration of the free layer with the programming current flow from the bottom to the top of the stack (from the free layer to the pinned layer);

FIG. 5 is a schematic top view of a second embodiment of a magnetic tunnel junction stack according to the disclosure, illustrating the magnetization configuration of the free layer;

FIG. 6 is a schematic top view of a third embodiment of a magnetic tunnel junction stack according to the disclosure, illustrating the magnetization configuration of the free layer;

FIG. 7 is a schematic top view of a fourth embodiment of a magnetic tunnel junction stack according to the disclosure, illustrating the magnetization configuration of the free layer; and

FIG. 8 is a schematic side view of a memory cell including a magnetic tunnel junction cell.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

This disclosure is directed to spin-transfer torque memory, also referred to as spin torque memory, spin torque RAM, or STRAM, and the magnetic tunnel junctions (MTJs) that are a part of the memory. The spin magnetic tunnel junction cells (MTJs) of this disclosure utilize a current ampere field to assist in the switching of the magnetization orientation of the free layer of the magnetic tunnel junction cell. Since both spin torque and current ampere field have an effect on the free layer magnetization, the switching current can be reduced. The magnetic tunnel junction cells of this invention have a free layer larger in size than the corresponding pinned layer, which allows non-uniform magnetization in the free layer without sacrificing readability. Additionally, the magnetic tunnel junction cells have improved thermal stability due to the increased volume of the free layers.

The magnetic tunnel junction cells of this disclosure are an individual, single stack, not connected or coupled to an adjacent or adjoining stack. A magnetic tunnel junction cell or stack, for this disclosure, has a single pinned layer, a single free layer, and a tunnel barrier layer therebetween. The magnetization orientation of the free layer is based on its corresponding pinned layer and the current passing through the cell (the magnetization orientation switchable by the spin torque and the ampere field from that current), and is not based on adjacent or adjoining cells, stacks, or other structures.

In the following description, reference is made to the accompanying set of drawings that forms a part hereof and in which are shown by way of illustration several specific embodiments. It is to be understood that other embodiments are contemplated and may be made without departing from the scope or spirit of the present disclosure. The following detailed description, therefore, is not to be taken in a limiting sense. The definitions provided herein are to facilitate understanding of certain terms used frequently herein and are not meant to limit the scope of the present disclosure.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the specification and attached claims are approximations that can vary depending upon the desired properties sought to be obtained by those skilled in the art utilizing the teachings disclosed herein.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

While the present disclosure is not so limited, an appreciation of various aspects of the disclosure and of the invention will be gained through a discussion of the Figures and the examples provided below.

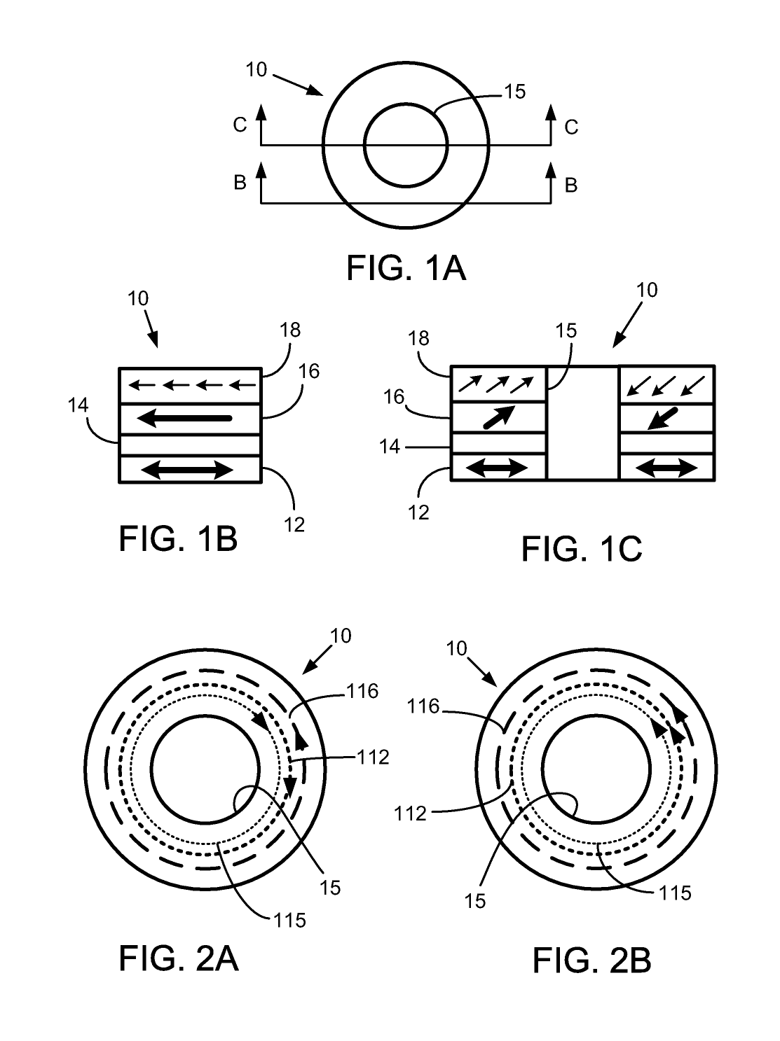

An annular magnetic tunnel junction cell is illustrated in FIGS. 1A through 1C as magnetic tunnel junction cell 10. Magnetic tunnel junction stack 10 has a ferromagnetic free layer 12, a nonmagnetic tunnel barrier 14, a ferromagnetic pinned layer 16, and an antiferromagnetic pinning layer 18, arranged with tunnel barrier 14 positioned between free layer 12 and pinned layer 16, and pinning layer 18 proximate pinned layer 16 opposite tunnel barrier 14. Tunnel barrier 14 spatially separates free layer 12 from pinned layer 16.

Each of free layer 12 and pinned layer 16 has a magnetic orientation or magnetization orientation associated therewith. Pinned layer 16 is pinned by antiferromagnetic pinning layer 18, or in other embodiments, may be a fixed layer without pinning but with a high coercivity to stabilize itself. Pinned layer 16 could be replaced by a synthetic antiferromagnetic (SAF) coupled structure, i.e., two ferromagnetic sublayers separated by a metallic spacer, such as Ru or Cu, with the magnetization orientations of the sublayers in opposite directions. Barrier layer 14 may be a nonmagnetic metallic material or a nonmagnetic metal oxide material. Tunneling barrier layer 14 could optionally be patterned with free layer 12 or with pinned layer 16, depending on process feasibility and device reliability. The various layers (i.e., free layer 12, tunnel barrier 14, pinned layer 16, and pinning layer 18) form an annular structure or ring structure having a central non-magnetic core 15. Core 15 may be an aperture (e.g., a void) or may a non-magnetic material.

The annular structure results in a non-uniform magnetization of free layer 12. In the embodiment illustrated in FIGS. 1B and 1C, the magnetizations of pinning layer 18 and pinned layer 16 encircle core 15 in a clockwise direction; in FIG. 1C, the magnetic moments point into the page on the left side of cell 10 and come out of the page on the right side of cell 10. In FIGS. 1B and 1C, free layer 12 has an undefined magnetization orientation.

To create magnetic tunnel junction cell 10, with the non-uniform magnetization of free layer 12, the annular stack is first made using well-known thin film techniques (e.g., chemical vapor deposition (CVD), physical vapor deposition (PVD), atomic layer deposition (ALD), photolithography, or other thin film processing techniques). The prepared stacks are placed at an elevated temperature (e.g., above the blocking temperature of pining layer 18) and then cooled down while a current is flowing through the stack. From this, the magnetizations of both free layer 12 and pinned layer 16 are aligned circularly in the annular structure. Moreover, the magnetization of pinned layer 16 is fixed by pinning layer 18 when the thermal process is completed.

Returning to the figures, particularly to FIGS. 2A and 2B, two magnetization states of magnetic tunnel junction cell 10 are illustrated. In FIG. 2A, magnetic tunnel junction cell 10 has a high resistance state, due to an electric current (programming current) flowing from the top to the bottom of the stack (from pinned layer 16 to free layer 12) through the layers. The spin torque, from the current flowing from pinned layer 16 to free layer 12, aligns the magnetization 112 of free layer 12 opposite to the magnetization 116 of pinned layer 16. In this embodiment, magnetization 112 of free layer 12 is clockwise, which is antiparallel to magnetization 116 of pinned layer 16, which is counterclockwise.

Also illustrated in FIG. 2A is ampere field 115, generated by the current (flowing into the page, in this orientation). Ampere field 115 also acts on magnetization 112 of free layer 12, facilitating the switching of magnetization 112 to be parallel to field 115 and thus antiparallel to magnetization 116 of pinned layer 16. With the help of ampere field 115, the switching of magnetization 116 occurs at a reduced current. The current to switch free layer 12, both via spin torque and the ampere field, is less than about 500 microAmps. The current may be pulsed, for example, as short as 1 ns or as long as 1 microsecond. Typically, as the pulse length decreases, the current amplitude increases.

In FIG. 2B, magnetic tunnel junction cell 10 has a low resistance state, due to an electric current (programming current) flowing from the bottom to the top of the stack (from free layer 12 to pinned layer 16) through the layers. The spin torque aligns magnetization 112 of free layer 12 the same as, or parallel to, magnetization 116 of pinned layer 16. In this embodiment, both magnetization 112 of free layer 12 and magnetization 116 of pinned layer 16 are counterclockwise. Ampere field 115 also acts on magnetization 112 of free layer 12, facilitating the switching of magnetization 112 to be parallel to field 115 and thus parallel to magnetization 116 of pinned layer 16. With the help of ampere field 115, the switching of magnetization 116 occurs at a reduced current.

The magnetic tunnel junctions of this invention, switched by spin torque and the current ampere field, have the vortex magnetization configuration, illustrated and discussed in relation to FIGS. 2A and 2B. The previous discussion has provided a basic understanding of magnetic tunnel junctions according to this invention and their operation and use. The general features and elements of the various embodiments of the magnetic tunnel junctions and methods of making them are similar or the same across the embodiments, unless otherwise indicated. By including a free layer that has a larger area than the pinned layer, switching of vortex magnetization orientations is facilitated by the ampere field created by the switching current.

In addition to the switching current reduction as a result of the ampere field, other benefits are recognized by having the vortex magnetization orientation. First, with the vortex structure, the magnetizations of the free layer and of the pinned layer are confined within the vortex structure, and are generally self-aligning. The orientation and the exact shape and size of the pinned layer and the free layer are less critical than in conventional stacks, where the layers have the same shape and size. Second, the magnetizations are circular within the free layer and the magnetic fluxes of the free layer and of the pinned layer are closed. Interaction between adjacent memory cells and between the current ampere field of adjacent memory cells are reduced and possibly eliminated. Additionally, crosstalk issues among adjacent cells are reduced and possibly eliminated. Reduced interaction among cells provides improved reliability.

The following examples illustrate magnetic tunnel junctions having a free layer larger than the pinned layer. The pinned layer is no more than about 50% or ½ the size or area of the free layer, and in many embodiments, is no more than about 35% (or about ⅓) the size of the free layer. In some embodiments, the pinned layer is no more than about 25% or ¼ of the size of the free layer. Described in alternate terms, the free layer is at least about 2× the size or area of the pinned layer, and in many embodiments, is at least about 3× the size of the pinned layer. In some embodiments, the free layer is at least about 4× of the size of the pinned layer. For example, if the pinned layer has a lateral size of about 100 nm the free layer will have a lateral size greater than 100 nm, in some embodiments 200 nm, in other embodiments about 300 nm, and in yet other embodiments about 400 nm. As another example, if the free layer has a lateral size of about 100 nm, the pinned layer has a lateral size of no more than about 50 nm, no more than about 35 nm, or even smaller.

In all embodiments, the pinned layer is offset from the center of the free layer, and is preferably positioned completely on one side of a central line of the free layer or on one half of the free layer. As will be seen from the following examples, the free layer may be a single element or may have multiple pieces or parts. For embodiments where the free layer is multiple parts, the pinned layer is preferably positioned completely on one side or half of the total area of the free layer. In some embodiments, the pinned layer may be completely on one of the multiple parts. In the illustrated embodiments, the pinned layer does not extend to an outer edge of the free layer, but is inset from the edge; in alternate embodiments, the pinned layer may extend to the edge.

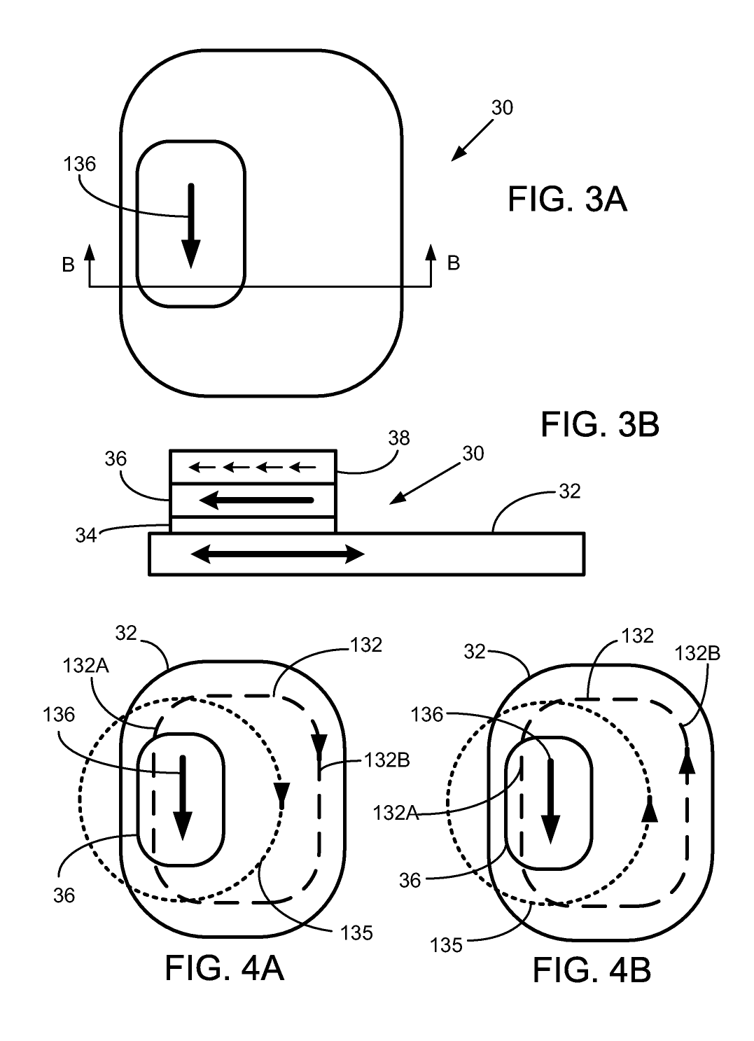

Referring to FIGS. 3A and 3B, a magnetic tunnel junction cell 30 is illustrated. Magnetic tunnel junction cell 30 has a ferromagnetic free layer 32, a nonmagnetic tunnel barrier 34, a ferromagnetic pinned layer 36, and an antiferromagnetic pinning layer 38, arranged with tunnel barrier 34 positioned between free layer 32 and pinned layer 36, and pinning layer 38 proximate pinned layer 36 opposite tunnel barrier 34. Free layer 32 is larger than (at least) pinned layer 36, and in this embodiment is larger than pinned layer 36, barrier layer 34 and pinning layer 38. In this embodiment, free layer 32 is larger than pinned layer 36 in width in both directions. Additionally, in this embodiment, the stack of barrier layer 34, pinned layer 36, pinning layer 38 is positioned offset from the center of free layer 32. The increased area of free layer 32 results in a non-uniform magnetization of free layer 32.

Magnetic tunnel junction cell 30 is an individual, single stack, not connected or coupled to an adjacent or adjoining stack. Magnetic tunnel junction cell 30 has a single pinned layer 36, a single free layer 32, and a single tunnel barrier layer 34 therebetween. Each of these layers, particularly free layer 32 and pinned layer 36, are defined by cell 30 and their boundaries are defined by cell 30. No portion of cell 30 extends to and connects to an adjacent or adjoining cell or stack.

In an alternate construction, barrier layer 34 is larger in size than pinned layer 36, and in some embodiments, barrier layer 34 may be the same increased size and/or shape as free layer 32. A construction having an increased barrier layer 34 may inhibit and/or reduce electrical shorting between pinned layer 36 and free layer 32. Additionally, during a manufacturing process of the memory cell, the etching process to make the stack can stop at barrier layer 34.

To create magnetic tunnel junction cell 30, the stack is first made using known thin film techniques (e.g., chemical vapor deposition (CVD), physical vapor deposition (PVD), atomic layer deposition (ALD), photolithography, or other thin film processing techniques), but forming a free layer that is larger than other layers. The size differential may be the result of the application step (e.g., a deposition step) or of a removal step (e.g., etching step).

Returning to the figures, particularly to FIGS. 4A and 4B, two magnetization states of magnetic tunnel junction cell 30 are illustrated. In FIG. 4A, magnetic tunnel junction cell 30 has a high resistance state, due to an electric current (programming current) flowing from the top to the bottom of the stack (from pinned layer 36 to free layer 32) through the layers. Magnetization 132 of free layer 32 extends clockwise, in this embodiment.

The spin torque, from the current flowing from pinned layer 36 to free layer 32, aligns the magnetic moments or magnetization 132 proximate the current pathway in free layer 32 to be antiparallel to magnetization 136 of pinned layer 36; this portion of magnetization 132 is labeled as magnetization 132A. Thus, the magnetic moments or magnetization portion 132A in free layer 32 proximate (e.g., below) pinned layer 36 is antiparallel to magnetization 136.

Also illustrated in FIG. 4A is ampere field 135, generated by the current flowing from pinned layer 36 to free layer 32. Ampere field 135 acts on magnetization 132 of free layer 32, strengthening magnetization portion 132A to be parallel to field 135 proximate pinned layer 36. Additionally, ampere field 135 acts on magnetization 132 of the remote area of free layer 32 (that is, the portion of free layer 32 not proximate pinned layer 36), aligning magnetization portion 132B parallel to magnetization 136 of pinned layer 36 due to the influence of ampere field 135. Therefore, a vortex structure of magnetization 132 of free layer 32 is formed. This vortex structure is energetically favored based on the interaction of the spin torque and the ampere field of the current.

In FIG. 4B, magnetic tunnel junction cell 30 has a low resistance state, due to an electric current (programming current) flowing from the bottom to the top of the stack (from free layer 32 to pinned layer 36) through the layers. Magnetization 132 of free layer 32 extends counterclockwise, in this embodiment, reverse to the high resistance state.

The spin torque, from the current flowing from free layer 32 to pinned layer 36, aligns the magnetic moments or magnetization 132A proximate free layer 32 to be parallel to magnetization 136 of pinned layer 36.

Ampere field 135 acts on magnetization 132 of free layer 32, strengthening magnetization portion 132A to be parallel to field 135 proximate pinned layer 36. Additionally, ampere field 135 acts on magnetization 132 of the remote area of free layer 32, aligning magnetization portion 132B parallel to magnetization 136 of pinned layer 36 due to the influence of ampere field 135. Therefore, a vortex structure of magnetization 132 of free layer 32 is formed. In this vortex structure, the magnetic moments generally twist in the free layer plane.

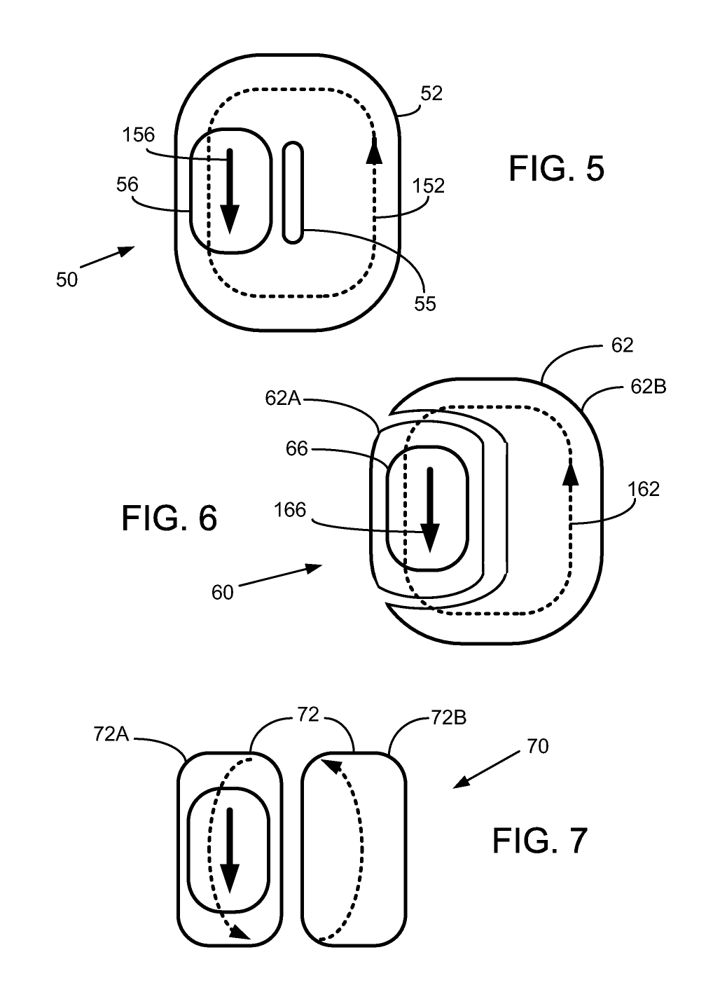

In an extended free layer, such as free layer 32, a magnetization singularity inevitably exists within the magnetization vortex structure. As the magnetization vortex center approaches the center of free layer 32, the energy increases around the center, and, with limited free layer available to accept the energy, the magnetic moments, at the center, twist to point out of the plane of the free layer, even though a large demagnetizing field acts against it. This singularity, in some embodiments, is undesirable. Furthermore, the singularity can be mobile in the free layer, causing a stability problem. An alternate design for magnetic tunnel junction stacks according to this invention has a disturbed, disrupted, or discontinuous free layer proximate the region where a singularity may form. Three various embodiments are illustrated in FIGS. 5, 6 and 7.

In FIG. 5, the free layer is an annular structure. With this design, the singularity is eliminated and the magnetization vortex structure is more stable than if the free layer were continuous. In FIG. 5, magnetic tunnel junction cell 50 has a free layer 52 larger than a pinned layer 56. Free layer 52 has a central aperture 55, have a shaped generally similar to the shape of free layer 52; in other embodiments, any central aperture may have a different shape. Not seen in FIG. 5 are a barrier layer and a pinning layer. Pinned layer 56 has a magnetization 156. In this embodiment, magnetic tunnel junction cell 50 has a low resistance state, with magnetization 152 of free layer 52 parallel to magnetization 156 in the region proximate pinned layer 56. The current ampere field, not illustrated herein, forms a vortex structure of magnetization 152.

Another design is illustrated in FIG. 6, with the free layer provided as two physically separated parts. In FIG. 6, magnetic tunnel junction cell 60 has a free layer 62 present as a smaller free layer part 62A and larger free layer part 62B. Pinned layer 66 is proximate free layer part 62A. Not seen in FIG. 6 are a barrier layer and a pinning layer proximate pinned layer 66. Pinned layer 66 has a magnetization 166. In this embodiment, magnetic tunnel junction cell 60 has a low resistance state, with magnetization 162 of free layer 62 in free layer part 62A parallel to magnetization 166. The spin torque from free layer part 62A to pinned layer 66 orients magnetization 162 proximate free layer part 62A, and the ampere field orients magnetization 162 proximate free layer part 62B. The magnetization of free layer part 62A and of free layer part 62B form a loop. After the programming current is removed, the magnetizations are magnetostatically coupled to each other to form a stable vortex structure.

Yet another design is illustrated in FIG. 7. Similar to magnetic tunnel junction cell 60 of FIG. 6, magnetic tunnel junction cell 70 has a free layer 72 present as free layer part 72A and free layer part 72B. In this embodiment, free layer part 72A and free layer part 72B are generally equal in shape and size. Free layer parts 72A, 72B may be easier to manufacture than free layer parts 62A, 62B, due to the rounded corners of parts 72A, 72B, however, the magnetostatic coupling may be less than for magnetic tunnel junction cell 60.

As seen in the previous examples, the free layer and the pinned layer can be patterned into different shapes and sizes. The shapes and relative sizes of the free layer and pinned layer can be designed or engineered to reduce the coupling field on the free layer and to obtain good thermal stability. For example, two free layer parts may have the same area but different shapes.

It is noted that although the previous embodiments have provided the pinned layer physically oriented above the free layer, the magnetic tunnel junction could be oriented otherwise, so that the free layer is on top of or above the pinned layer.

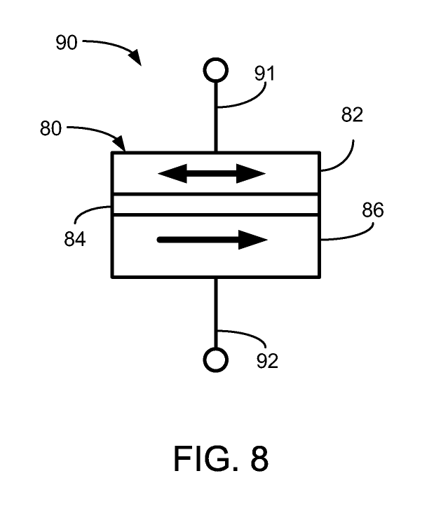

The various magnetic tunnel junctions described above and others according to this disclosure can be incorporated into spin-transfer torque memory or STRAM. FIG. 8 illustrates STRAM 90, with a generic magnetic tunnel junction cell 80 according to this disclosure. Magnetic tunnel junction cell 80 includes a ferromagnetic free layer 82, a barrier or tunnel layer 84, and a ferromagnetic pinned layer 86. A first electrode 91 is in electrical contact with free layer 82 and a second electrode 92 is in electrical contact with pinned layer 86. Not illustrated, a pinning layer may be positioned between pinned layer 86 and electrode 92.

Electrodes 91, 92 electrically connect magnetic tunnel junction cell 80 to a control circuit providing read and write currents through magnetic tunnel junction cell 80 and layers 82, 86. Electrodes 91, 92 provide the current that orients free layer 82 via spin torque and that also provides the ampere field. The resistance magnetic tunnel junction cell 80 is determined by the relative orientation of the magnetization or magnetization orientations of free layer 82 and pinned layer 86.

If the magnetic orientations of free layer 82 and pinned layer 86 were parallel, magnetic tunnel junction cell 80 would be in low resistance state or “0” data state. If the magnetic orientations of free layer 82 and pinned layer 86 were opposite or antiparallel, magnetic tunnel junction cell 80 would be in high resistance state or “1” data state. Switching the resistance state and hence the data state of magnetic tunnel junction cell 80 via spin torque occurs when a current, passing through a magnetic layer of magnetic tunnel junction cell 80, becomes spin polarized and imparts a spin torque on free layer 82. When a sufficient spin torque is applied to free layer 82, the magnetization orientation of free layer 82 can be switched between two opposite directions and, accordingly, magnetic tunnel junction cell 80 can be switched between the parallel state (i.e., low resistance state or “0” data state) and antiparallel state (i.e., high resistance state or “1” data state) depending on the direction of the current. The ampere field from the current facilitates the orientation of the magnetization of free layer 82.

The illustrative spin torque magnetic tunnel junction cell 80 may be used to construct a memory device that includes multiple magnetic tunnel junctions 80 where a data bit is stored in magnetic tunnel junctions 80 by changing the relative magnetization state of free magnetic layer 82 with respect to pinned magnetic layer 86. The stored data bit can be read out by measuring the resistance of magnetic tunnel junction cell 80 which changes with the magnetization direction of the free layer relative to the pinned layer. In order for magnetic tunnel junction cell 80 to have the characteristics of a non-volatile random access memory, the free layer exhibits thermal stability against random fluctuations so that the orientation of the free layer is changed only when it is controlled to make such a change. This thermal stability can be achieved via the magnetic anisotropy using different methods, e.g., varying the bit size, shape, and crystalline anisotropy. Additional anisotropy can be obtained through magnetic coupling to other magnetic layers either through exchange or magnetic fields. Generally, the anisotropy causes a soft and hard axis to form in thin magnetic layers. The hard and soft axes are defined by the magnitude of the external energy, usually in the form of a magnetic field, needed to fully rotate (saturate) the direction of the magnetization in that direction, with the hard axis requiring a higher saturation magnetic field. Additionally, the increased size of the free layer in relation to the pinned layer, as in accordance with this invention, increases the thermal stability of the free layer.

Thus, embodiments of the STRAM CELLS WITH AMPERE FIELD ASSISTED SWITCHING are disclosed. The implementations described above and other implementations are within the scope of the following claims. One skilled in the art will appreciate that the present disclosure can be practiced with embodiments other than those disclosed. The disclosed embodiments are presented for purposes of illustration and not limitation, and the present invention is limited only by the claims that follow.

What is claimed is:

1. An individual magnetic tunnel junction cell comprising a ferromagnetic pinned layer, a ferromagnetic free layer, and a non-magnetic barrier layer therebetween, the free layer having an area at least twice the size of the pinned layer.

2. The magnetic tunnel junction cell of claim 1 wherein the free layer has an area at least three times the size of the pinned layer.

3. The magnetic tunnel junction cell of claim 1 wherein the free layer has an area at least four times the size of the pinned layer.

4. The magnetic tunnel junction cell of claim 1 wherein the free layer comprises a first part and a second part spaced from the first part.

5. The magnetic tunnel junction cell of claim 4 wherein the first part and the second part are the same size and shape.

6. The magnetic tunnel junction cell of claim 4 wherein the pinned layer is present completely within the first part of the free layer.

7. An individual magnetic tunnel junction cell comprising a ferromagnetic pinned layer, a ferromagnetic free layer, and a non-magnetic barrier layer therebetween, the free layer having an area larger than that of the pinned layer, with the pinned layer offset from a center of the free layer.

8. The magnetic tunnel junction cell of claim 7 wherein the free layer has an area at least two times the size of the pinned layer.

9. The magnetic tunnel junction cell of claim 7 wherein the free layer has an area at least three times the size of the pinned layer.

10. The magnetic tunnel junction cell of claim 7 wherein the free layer has an area at least four times the size of the pinned layer.

11. The magnetic tunnel junction cell of claim 7 wherein the free layer comprises a first part and a second part spaced from the first part.

12. The magnetic tunnel junction cell of claim 11 wherein the first part and the second part are the same size and shape.

13. The magnetic tunnel junction cell of claim 11 wherein the pinned layer is present completely within the first part of the free layer.

14. A magnetic tunnel junction cell comprising:
a ferromagnetic pinned layer having a fixed magnetization;
a ferromagnetic free layer with an area larger than that of the pinned layer, the free layer having a changeable vortex magnetization; and
a non-magnetic barrier layer between the pinned layer and the free layer.

15. The magnetic tunnel junction cell of claim 14 wherein the pinned layer is offset from a center of the free layer.

16. The magnetic tunnel junction cell of claim 14 wherein the free layer has an area at least two times the size of the pinned layer.

17. The magnetic tunnel junction cell of claim 14 wherein the free layer comprises a first part and a second part spaced from the first part.

18. The magnetic tunnel junction cell of claim 14 wherein the vortex magnetization is changeable between clockwise and counterclockwise.

19. The magnetic tunnel junction cell of claim 18 wherein the magnetization of the pinned layer is fixed antiparallel to the vortex magnetization of the free layer proximate the pinned layer.

20. The magnetic tunnel junction cell of claim 18 wherein the magnetization of the pinned layer is fixed parallel to the vortex magnetization of the free layer proximate the pinned layer.
